(19) United States
(12) Patent Application Publication
(10) Pub. No.: US 2018/0319099 A1
(43) Pub. Date: Nov. 8, 2018

(54) Method for Increasing the Rigidity of Nonwoven Moldings by Way of Additive Manufacturing

(71) Applicant: Sandler AG, Schwarzenbach (DE)

(72) Inventor: Heinrich Sommer, Oberkotzau (DE)

(21) Appl. No.: 15/968,862

(22) Filed: May 2, 2018

(30) Foreign Application Priority Data
May 4, 2017 (DE) 102017109551.9

(51) Int. Cl. B29C 69/02; B29C 64/118; B33Y 10/00; B33Y 80/00

(52) U.S. Cl. CPC B29C 69/02; B29C 64/118; B60R 13/00; B33Y 80/00; B33Y 10/00

(57) ABSTRACT

Method for manufacturing a component, in particular for a motor vehicle, in which a nonwoven is provided with strip-shaped plastic materials by way of 3D printing, and the strip-shaped plastic bodies applied by way of 3D printing are subsequently pressed into the nonwoven while supplying heat and pressure. The strip-shaped plastic bodies can be reinforcing ribs. The strip-shaped plastic bodies can be applied in the regions of the nonwoven where increased component stresses occur during later use. The strip-shaped plastic bodies applied can be thermoplastic material, fiber-reinforced thermoplastic material or thermoset material.

### CROSS-REFERENCE TO RELATED APPLICATIONS

The present application claims priority benefit to German Patent Application No. 102017109551.9, filed May 4, 2017. The disclosure of the foregoing application is incorporated herein by reference in its entirety.

### FIELD OF THE INVENTION

The present invention relates to a method for increasing the rigidity of nonwoven moldings by way of additive manufacturing. The invention relates in particular to a method for manufacturing a component, specifically fora motor vehicle, and to a component manufactured thereby.

### BACKGROUND

In prior art, such components are produced predominantly by way of injection-molding tools. A nonwoven to be stiffened is there placed in an injection-molding tool and preheated before plastic material is applied to it. The larger the surface of the component to be manufactured, the larger the injection-molding tools and the corresponding machines must be configured. The required system technology then becomes very complex.

The increase in niche and special models of automobile manufacturers is there reflected in a lower number of order quantities. In the case of small vehicle series, the investment costs for complex injection-molding tools outweigh disproportionately relative to the individual costs of the components.

DE 10 2011 009 148 A1 discloses a method for manufacturing a component, in particular for a motor vehicle, in which a nonwoven is at least in sections provided with plastic material, characterized in that the nonwoven is heated temporally prior to being provided with the plastic material. In this method, the nonwoven is at least in sections inserted into an injection-molding tool and provided with the plastic material by way of the injection-molding tool.

DE 10 2004 009 245 A1 discloses a method and a plastic molding made of a nonwoven and plastic material in which the side of the nonwoven layer facing away from the plastic material has a structuring which forms the final pattern of the plastic molding.

### SUMMARY

It is therefore an object of the present invention to provide an inexpensive and flexible method for manufacturing reinforced components, in particular for a motor vehicle. Furthermore, it is an object of the invention to provide a reinforced component, in particular for a motor vehicle.

This object is satisfied by a method for manufacturing a component having the features as described herein, and by a corresponding component having the features as described herein. Preferred embodiments and further developments of the invention are also provided.

The first aspect of the invention relates to a method for manufacturing a component, in particular for a motor vehicle, in which a nonwoven is at least in sections provided with plastic material. The plastic material to be applied is one or more plastic bodies having a strip shape, which are applied by way of 3D printing. “3D printing” is understood to cover all additive or generative manufacturing processes in which a material is printed in layers onto a nonwoven. 3D printing processes have the advantage of being able to apply plastic bodies to nonwoven fabric without having to produce injection-molding tools for this, which enables cheaper production. The strip-shaped plastic bodies to be applied can be any plastic material that can be applied to the nonwoven by way of 3D printing. 3D printers have the advantage that they are widely represented in the market for fine and coarse printing processes and their spare parts are easy to obtain. The completed component has a selectively increased flexural rigidity and can be installed, for example, at a vehicle underside.

The plastic bodies applied to the nonwoven fabric by way of 3D printing are subsequently pressed onto the nonwoven while advantageously supplying pressure and heat. The component then exhibits a uniform thickness and its integration in the intended installation space is greatly facilitated.

According to one configuration of the invention, the strip-shaped plastic bodies are reinforcing ribs. Reinforcing ribs increase the flexural strength of the component and increase the weight of the component only to a small degree.

The reinforcing ribs can form any random geometry. In one advantageous configuration, the reinforcing ribs can be applied as honeycomb structures. They have the advantage of increasing the flexural strength of the nonwoven fabric to a particularly large degree while adding little weight.

According to a further configuration, the reinforcing ribs are applied in the regions of the nonwoven in which increased component stresses occur during later use. Components can thereby be made even lighter by being reinforced only in those regions where they are mechanically stressed.

According to one further configuration of the invention, strip-shaped plastic bodies are printed on both sides of the nonwoven. This arrangement has the advantage that it can increase the flexural strength of the component on both sides of the nonwoven.

According to one advantageous configuration of the invention, the strip-shaped plastic bodies applied on one side of the nonwoven are located opposite the strip-shaped plastic bodies applied on the other side of the nonwoven. Such structures are also designed in the art to form sandwich structures and enable the absorption of increased flexural stresses in the form of compressive and tensile forces while adding little structural mass due to the reinforcements.

The nonwoven is advantageously thermally bonded nonwoven fabric with melt fibers. Thermally bonded nonwoven fabrics have the advantage that they exhibit increased rigidity. Furthermore, nonwoven fabrics with melt fibers can be more deformed with heat input, which improves the processability of the nonwoven.

According to one further advantageous configuration of the invention, the melting point of the thermoplastic strip-shaped plastic bodies is above that of the melt fibers of the nonwoven. As a result, the nonwoven fabric and the strip-shaped plastic bodies applied can be heated beyond the melting point of the melt fiber of the nonwoven so that the strip-shaped plastic bodies are pressed into the nonwoven fabric without being deformed.

The nonwoven can be produced as a near-net-shape nonwoven. Near-net-shape nonwoven has the advantage that it does not have to be cut during or after the process, so it already has dimensions close to installation prior to the reinforcement.

In addition, the nonwoven can be produced as a pre-deformed nonwoven. This facilitates the respective thermoforming process which can be limited to pressing the strip-shaped plastic body into the nonwoven.

The strip-shaped plastic bodies to be applied can be thermoplastic material which is applied by way of fused deposition modeling. Thermoplastics have the advantage that they are deformable several times within certain temperature ranges. A respective component can advantageously be welded to other thermoplastic connection points.

The strip-shaped plastic bodies can be printed on using fiber-reinforced filaments. Fiber-reinforced thermoplastic bodies can increase the flexural strength of the component at high loads more than strip-shaped plastic bodies that are not fiber reinforced.

According to a further configuration of the invention, the strip-shaped plastic bodies to be applied are thermoset ribs which are applied by way of resin that is UV-cured in layers. Thermosets are advantageous for reinforcing nonwovens which are to exhibit increased flexural strength under high temperature influence.

According to one further configuration, the method according to the invention can additionally comprise a step in which the nonwoven is cut to shape prior to the application of the strip-shaped plastic bodies. With this configuration, components according to the invention can advantageously be produced from large nonwovens.

According to an advantageous configuration of the invention, the method additionally comprises the removal of the nonwoven to be cut to shape from a nonwoven fabric line. A device of this kind can provide the nonwoven in an automated manner and makes possible the use of the method for mass production of components.

The second aspect of the invention relates to a component which is manufactured by use of a method according to the invention. The component comprises nonwoven fabric and one or more strip-shaped plastic bodies. The geometry and the position of the strip-shaped plastic bodies can advantageously depend on the mechanical loads planned for the component. In this regard, software changes suffice for respectively adapting components to be manufactured. Such components can advantageously be realized quickly and inexpensively.

Advantageous configurations and embodiments of the method having the features as described yield advantageous configurations of the component having the features as described.

### BRIEF DESCRIPTION OF THE DRAWINGS

FIG. 1 shows a nonwoven for use in a method according to the invention;

FIG. 2 shows a component having a strip-shaped plastic body applied onto nonwoven fabric by way of 3D printing;

FIG. 3 shows a variant of a component having the strip-shaped plastic body pressed into the nonwoven while heat and pressure is supplied;

FIG. 4 shows a variant of a component having strip-shaped plastic bodies printed on and pressed into both sides of the nonwoven;

FIG. 5 shows a variant of a component having the strip-shaped plastic body printed on in the shape of a diamond structure;

FIG. 6 shows a variant of a component having strip-shaped plastic bodies in the shape of a honeycomb structure printed onto both sides of the nonwoven and pressed into the nonwoven.

### DETAILED DESCRIPTION

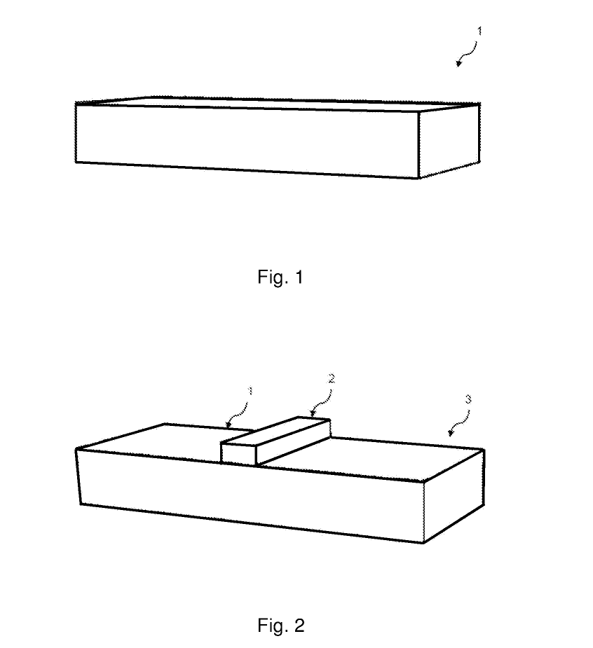

Embodiments of the invention are explained in detail using the drawings of FIGS. 1-6.

FIGS. 1-2 each show a nonwoven 1, a strip-shaped plastic body 2 and a component 3.

FIG. 1 shows nonwoven 1 to be treated in the first step of the method by way of an additive method. Nonwoven 1 is a mixed fiber nonwoven with a high melt fiber content. Nonwoven 1 is, for example, one that is sold by the applicant under the trade name SAWAFORM®. The melting point of the melt fibers of a nonwoven of the kind mentioned is, for example, 110° C. The additive method is, for example, fused deposition modeling suitable for applying thermoplastics such as polypropylene (PP). A component 3 according to the invention, as shown in FIG. 2, is created from nonwoven 1 on which a strip-shaped plastic body 2 has been applied by way of 3D printing.

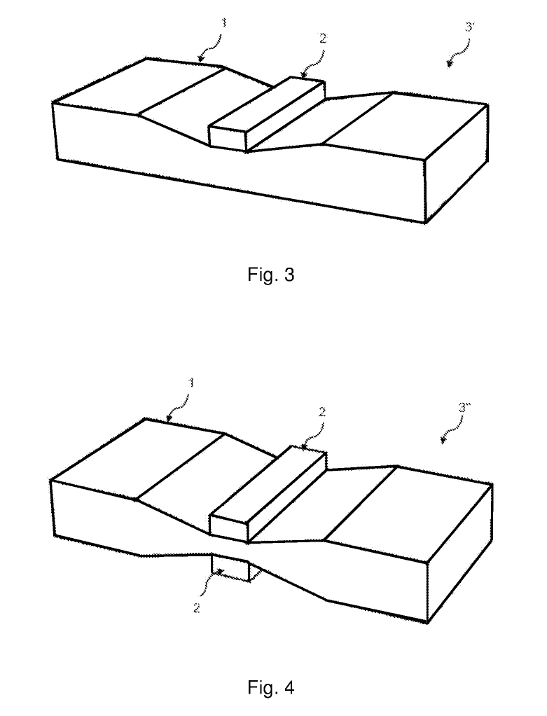

In one advantageous configuration of the method according to the invention, component 3 formed in the first step is processed while supplying heat and pressure so that the strip-shaped plastic body 2, which was applied additively to nonwoven 1, is pressed into the same nonwoven 1. Since the strip-shaped plastic body 2 is, for example, PP, i.e. thermoplastic material, the latter should exhibit a higher melting point than the melt fibers of nonwoven 1, so that when supplying heat and pressure, strip-shaped plastic body 2 does not deform before the melting point of the melt fibers of nonwoven 1 has been reached. Strip-shaped plastic body 2 can then be pressed as a thermoplastic material into nonwoven 1 without deforming it. In this embodiment, the heat and pressure supply is realized in a thermoforming process. In this configuration of the method according to the invention, the variant of component 3′ according to the invention arises which is shown in FIG. 3 and has a uniform thickness whereby its installation is simplified.

If necessary, the number, the geometry and the position of the strip-shaped plastic bodies can be adapted. In one advantageous configuration, strip-shaped plastic body 2 is a reinforcing rib which increases the flexural strength of nonwoven 1.

In a further configuration, nonwoven 1 can be pre-deformed prior to the first and second step of the method according to the invention, for example in a thermoforming process. For example, strip-shaped plastic bodies 2 are then applied where increased mechanical stresses occur during the subsequent use of component 3 arise.

FIG. 4 shows a further configuration of component 3″ according to the invention, produced in a further configuration of the method according to the invention. The method according to the invention was amended such that a respective strip-shaped plastic body 2 was applied in an additive manner on both sides of nonwoven 1. This can be realized, for example, with two consecutive or parallel 3D printing processes. In this configuration, strip-shaped plastic bodies 4 are applied on both sides of nonwoven 1 and form a partial sandwich structure. Nonwoven 1 used and the material of strip-shaped plastic bodies 2 are the same as in the previous embodiments 3 and 3′.

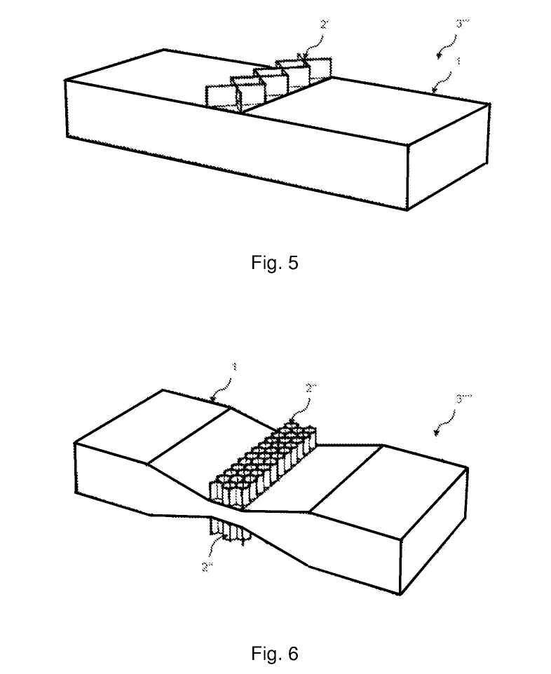

FIG. 5 shows a further embodiment of a component 3′″ according to the invention in which strip-shaped plastic body 2′ was printed three-dimensionally in the form of a cross-ribbed structure onto nonwoven 1.

FIG. 6 shows a further embodiment of a component 3′″ according to the invention in which strip-shaped plastic body 2″ pas printed in the form of a honeycomb structure three-dimensionally onto both sides of nonwoven 1 and pressed into nonwoven 1 while supplying heat and pressure to form a partial sandwich structure.

Furthermore, strip-shaped plastic body 2 can be applied using fiber-reinforced filaments. Strip-shaped plastic bodies 2 to be applied and the additive method can be thermoset ribs which are applied by way of resin that is UV-cured in layers.

In a further configuration of the method according to the invention, a nonwoven 1 is cut to size in a first step in a blanking station. This results in a nonwoven 1 cut to shape. The nonwoven cut to shape which has, for example, the same fiber content as nonwoven 1 from the first two configurations is then subjected to the respective first and the second process step by way of a 3D printing process with subsequent supply of heat and pressure.

The various configurations of the invention allow for a selective increase in rigidity, depending on the mechanical component loads.

In addition, the invention enables inexpensive manufacture of components for both smaller and larger vehicle series.

Design changes with respect to the location and geometry of the strip-shaped plastic bodies can be made relatively easily and quickly by amending the executing software without any hardware changes.

The method according to the invention can also be automated with respective production logistics. For example, a nonwoven fabric line can supply, for example, a station in which a nonwoven is cut to shape and stored. The removal of nonwoven blanks can be performed by robots that position them in order to apply strip-shaped plastic bodies 2, where the application of strip-shaped plastic bodies 2 is realized by several three-dimensional printers installed in parallel. The removal of nonwoven semi-finished products 2 from the printing station and their positioning in the thermoforming press can also be performed by a robot. The components can be directly removed, stacked and/or packaged.

1. A Method for manufacturing a motor vehicle component, in which a nonwoven is at least in sections provided with plastic material, characterized in that one or more strip-shaped plastic bodies are applied onto said nonwoven by way of 3D printing.

2. The Method according to claim 1, characterized in that said strip-shaped plastic body or bodies applied are then pressed into said nonwoven while heat and pressure is supplied.

3. The Method according to claim 1, characterized in that said strip-shaped plastic bodies are reinforcing ribs.

4. The Method according to claim 3, characterized in that said reinforcing ribs are printed on in regions of said nonwoven in which increased component stresses arise during later use.

5. The Method according to claim 3, characterized in that said reinforcing ribs are applied in the shape of honeycomb structures or cross-ribbed structures.

6. The Method according to claim 1, characterized in that said nonwoven has strip-shaped plastic bodies printed onto both sides.

7. The Method according to claim 6, characterized in that said strip-shaped plastic bodies applied onto one side of said nonwoven are located opposite to said strip-shaped plastic bodies printed onto the other side of said nonwoven.

8. The Method according to claim 7, characterized in that said strip-shaped plastic bodies applied onto both sides of said nonwoven are pressed into said nonwoven while forming partial sandwich structures.

9. The Method according to claim 1, characterized in that said nonwoven is thermally bonded nonwoven fabric or a mixed fiber nonwoven with melt fibers.

10. The Method according to claim 9, characterized in that the melting point of said strip-shaped plastic bodies is above that of said melt fiber of said nonwoven.

11. The Method according to claim 1, characterized in that said nonwoven is manufactured as a near-net-shape nonwoven.

12. The Method according to claim 1, characterized in that said nonwoven is produced as a pre-deformed nonwoven.

13. The Method according to claim 1, characterized in that said strip-shaped plastic bodies to be applied are thermoplastic material which is applied by way of fused deposition modeling.

14. The Method according to claim 1, characterized in that said strip-shaped plastic bodies are printed on by using fiber-reinforced filaments.

15. The Method according to claim 1, characterized in that said strip-shaped plastic bodies to be applied are thermoset ribs which are applied by way of resin that is UV-cured in layers.

16. The Method according to claim 1, characterized in that said nonwoven is cut to shape prior to the application of said strip-shaped plastic bodies.

17. The Method according to claim 16, characterized in that said nonwoven to be cut to shape is removed from a nonwoven fabric line.

18. A Component manufactured using the method according to claim 1 comprising a nonwoven and strip-shaped plastic bodies, characterized in that said strip-shaped plastic bodies are applied by way of 3D printing.
